(19) United States
(12) Patent Application Publication
(10) Pub. No.: US 2018/0232448 A1
(43) Pub. Date: Aug. 16, 2018

(54) Presenting Search Results Online

(71) Applicant: Chian Chiu Li, Fremont, CA (US)

(72) Inventor: Chian Chiu Li, Fremont, CA (US)

(21) Appl. No.: 15/430,465

(22) Filed: Feb. 11, 2017

(51) Int. Cl. G06F 17/30

(52) U.S. Cl. CPC G06F 17/30864; G06F 3/167; G06F 17/30991

(57) ABSTRACT

Systems and methods for presenting search results after receiving a query from a user. In a search window, search and comparison options are presented side by side. The search option provides search results based on the query. The comparison option provides comparison results based on an object derived from the query and selected comparators that are comparable to the object. Comparison results are presented in a concise format. In another aspect, comparison attributes are created for a database. Comparison attributes contain comparison information.

### FEDERALLY SPONSORED RESEARCH

Not applicable

### SEQUENCE LISTING OR PROGRAM

Not applicable

### BACKGROUND

### Field of Invention

This invention relates to presenting online search results, more particularly to presenting search and comparisons results using comparison attributes of a database.

### BACKGROUND

### Description of Prior Art

The Internet has become a colossal reservoir of data where we try to store almost everything which is digital. The reservoir may contain a vast amount of information covering all kinds of subjects, objects, and areas, like knowledge, data collected, records of personal and collective experiences, records of events and activities, or in some occasions, any digital info we could have. When a user wants to learn something, the user may log on a searching website to get lots of web page links, which may provide ample information on an object, such as what it is, its contact or access info, reviews, comments, and other related info posted on the Internet. A conventional search result, however, doesn't provide comparison results among competitors or similar objects directly. A conventional search may present direct introduction to an object, but not how it compares with other objects. When a user wants to see a comparison result, the user has to find online reviews first. But many objects don't have reviews. Even when reviews are available, a user has to spend time reading through them, which may not be practical in cases when immediate answer is needed like in front of a restaurant or in a shopping mall. Thus, it's inconvenient to get comparison results using a conventional search method.

In our daily life, comparison results are important and desirable many a time. For instance, when a user is about to purchase a product, the user may want to compare it with other similar products in terms of price, reviews, and specifications. Currently, an online search is conducted around an object, not relations between an object and other objects. This is the only option provided for a user, i.e., a query-focused search option. A user may have to do a search, rake out useful webpage links from pages of search results, get review articles, and then compare an object with another one. Thus even though it is not easy to get comparison results from a conventional search, as it is indirect, requires several steps, and may need some summarization skills, it is the only option available for a user. Therefore, there exists a need for an improved search process which provides not only an option for conventional search results, but also another option for comparison results.

A database is an organized collection of data sets. It provides for storage and retrieval of data or information electronically and efficiently. There are different database types utilizing different structures to organize data sets. Take one common database structure for instance. It may contain a database table having rows and columns. Each data set may be a row, which may also be called a record or entity. An entity may contain corresponding column units of the database table, which may be called fields or attributes. For applications in conventional search and some other occasions, a regular database may consist of entities. Each entity may represent an object and contain attributes. The attributes may contain info of the object.

Usually a database features a large amount of entities. For a database used for conventional search, its entities or the entity's attributes only contain info on objects, like an object's meaning, property, and links to web pages where related info are arranged. But the entities or attributes don't include data which may be used to present comparison results among certain objects. For instance, if an object is “Pizza Time”, the attributes may involve a brief introduction of the eatery, its menu, open hours, street address, phone number, and website address. The attributes normally don't contain comparison data which is ready for retrieval for “Pizza Time” and nearby competing pizza places. To compare it with others, a user may have to do some searches, obtain relevant information, and get comparison results manually. The above comparison process requires certain knowledge, patience, and skills and thus is not a method for all users. Therefore, there exists a need to provide an improved database which contains comparison data for direct retrieval.

### TARGETS AND ADVANTAGES

Accordingly, several main targets and advantages of the present invention are: p1 a). to provide an improved system and method to present online search results;
b). to provide such a system and method which provide a search option and a comparison option simultaneously;
c). to provide such a system and method which present comparison results using concise summaries;
d). to provide such a system and method which produce a database having comparison attributes; and
e). to provide such a system and method which create comparison attributes for direct retrieval of comparison data.

Further goals and advantages will become apparent from a consideration of the drawings and ensuing description.

### SUMMARY

In accordance with the present invention, search and comparison options are presented in a search window simultaneously. The search option provides conventional search results. The comparison option provides comparison results among an object and other objects. Comparison results are presented using concise summaries which feature the same format, similar or same wording, and/or a few items only. To accommodate needs of presenting comparison results, comparison attributes are created and added to a database. Comparison attributes enable quick retrieval of comparison information.

### DRAWING FIGURES

FIG. 1 is a block diagram showing a prior-art network environment.

FIG. 2 is a block diagram showing a prior-art server 16 of FIG. 1.

FIG. 3 is a schematic block diagram of a log processing system of a server in accordance with the present invention.

FIG. 4 is a schematic block diagram of a searching system of a server in accordance with the present invention.

FIG. 5 is a schematic flow diagram showing a process to collect info, obtain comparison data, and create attributes and an entity in accordance with the present invention.

FIG. 6 is a schematic flow diagram showing processes to retrieve and send search results and comparison results respectively in accordance with the present invention.

FIG. 7 is a schematic block diagram of a client system in accordance with the present invention.

FIGS. 8-A and 8-B are exemplary diagrams showing search and comparison options in a search interface in accordance with the present invention.

FIGS. 8-C to 8-F are exemplary diagrams showing comparison results in a search interface in accordance with the present invention.

FIG. 9 is a schematic flow diagram describing search and compare processes respectively in accordance with the present invention.

### REFERENCE NUMERALS IN DRAWINGS

| | | | |
|---|---|---|---|
| 10 | Client | 12 | Communication Network |
| 14 | Input Module | 16 | Server |
| 18 | Output Module | 20 | Presentation Module |
| 22 | Memory & Storage | 24 | Processing Module |
| 26 | Communication Interface | 28 | Bus |
| 30 | Front End | 32 | Processing Unit |
| 34 | Site Storage | 36 | Log Data Storage |
| 38 | Search Module | 40 | Log Processing System |
| 42 | Searching System | 44 | Computer Readable Medium |
| 46 | Processor | 48 | Client |
| 50 | Display | 52 | Query Input Window |
| 54 | Search Button | 56 | Comparison Button |
| 58 | Comparison Window | 60 | Button |
| 62 | Button | 64 | Display Surface |
| 66 | Comparison Window | | |

100, 102, 104, 106, 108, 110, 112, 114, 116, 118, 120, 122, 124, 126,
128, 130, 132, 134, 136, 138, 140, 142, 144, and 146 are exemplary steps.

### DETAILED DESCRIPTION

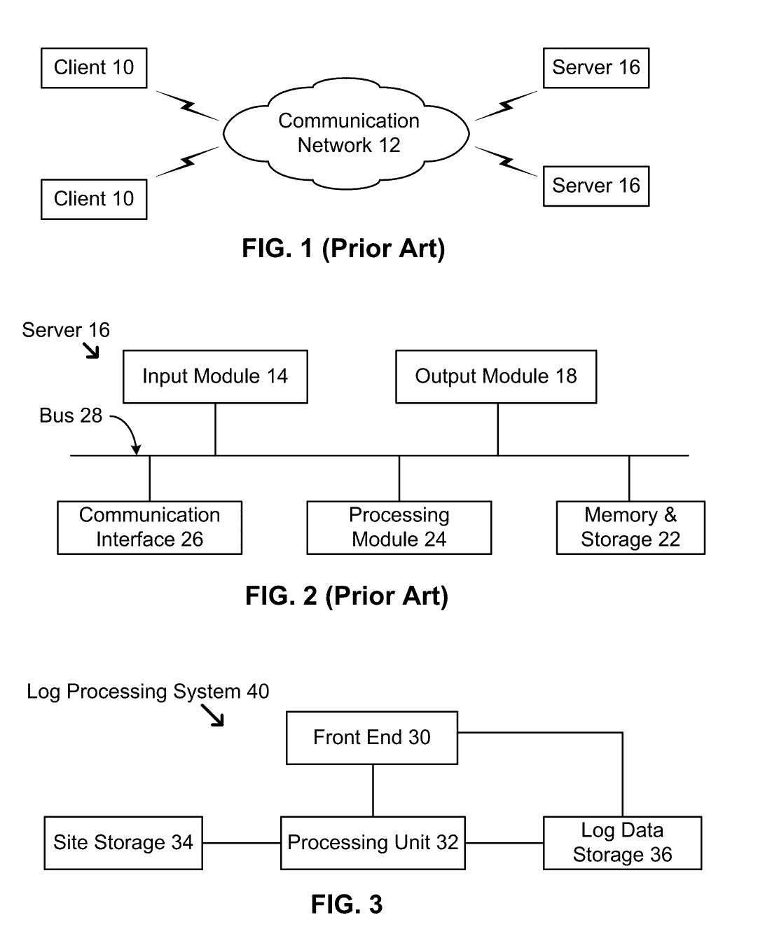

FIG. 1 is an exemplary diagram of a prior-art network system which may be used to implement the principles of current invention. The network system may comprise clients 10 and servers 16 which are connected via a communication network 12. The numbers of clients and servers in FIG. 1 are arbitrary for illustrating principles only. The clients or servers may be the same or different in characteristics and their functionality may change in practical applications.

Clients 10 may cover a range of real or virtual things such as a thread or process running on a device, an object executable by a device, an electronic device or gadget, e.g., a desktop computer, a notebook computer, a tablet computer, a smartphone, a smart watch, a virtual reality (VR) device, an augmented reality (AR) device, and the like.

The word “server” used in here means a system or systems which may have similar functions and capacities as one or more servers. Main components of server may include one or more processors, which control and process data and information by executing software, logic, or codes, or carrying out any other suitable functions. A server and/or processor, as a computing device, may include any hardware, firmware, software, or a combination. In the most compact form, thanks to the progress of microelectronics, a server may be built on a single processor chip. In the figure, servers 16 may represent one or more server devices that collect, process, store, maintain, and/or manage information and documents, execute a search process requested by a user and deliver search results to the user.

Network 12 may cover a range of types such as a local area network (LAN), a wide area network (WAN), a telephone network, an intranet, the Internet, wireless, and other types of networks. Clients 10 and servers 16 may be connected to network 12 or among themselves by various wired, wireless, optical, direct or relayed connections.

FIG. 2 is a schematic block diagram of prior-art server 16 of FIG.1. Server 16 may comprise an input module 14, an output module 18, a memory & storage module 22, a processing module 24, a communication interface 26, and a bus 28. Bus 28 provides communication means among the modules and devices.

Input module 14 may comprise a function that permits and enables an operator to feed information to server 16. Keyboard, mouse, voice or gesture recognition devices are examples of module 14. Output module 18 presents or displays output information. Examples of output module are monitor, printer, smart phone, or other information output devices. Memory & storage module 22 may comprises random access memory (RAM), read only memory (ROM), magnetic storage, optical storage, or other memory and storage media. Processing module 24 may comprise various types of processors which receive and execute instructions. Communication interface 26 may comprise any communication mechanism that enables server 16 to exchange information with other devices and systems either locally through bus 28 or remotely through network 12.

Processing module 24 may process information or documents obtained from web pages of various web sites, generate data associated with the web sites, and then store the data using memory & storage 22. Module 24 may also access information stored in memory & storage 22 to acquire needed data. Module 24 may perform these operations in response to executable software instructions kept in a computer-readable medium, such the RAM or ROM part of device 22.

FIG. 3 is a schematic functional block diagram of a log processing system 40 of a server according to the present invention. System 40 may comprise a front end 30, a processing unit 32, site storage 34, and log data storage 36. The blocks each may represent processor, thread, and/or object. The blocks or functions depicted here and in other figures may be implemented in software, hardware, or a combination of hardware and software. Using integration or system-on-chip technology, system 40 and other systems described here may also be built by less blocks or chips, or even a single block or single chip to realize functions pursued, and to reduce the system size and power consumption.

Front end 30 works as the front end of log processing system 40 and receives information or documents related to users and user access of web pages and web sites such as hypertext transfer protocol (HTTP) requests. Web access information of users includes visits on various sites and web pages, which may be sent to and stored in log data storage 36. Log storage 36, as shown in FIG. 3, is directly connected to front end 30. It stores data transferred via front end 30, which may include other user related info which is either submitted by users or collected via other means, such as user name, password, URL, geographic location, online survey records, online search records, etc.

Processing unit 32 may analyze a user by information stored in log data storage 36 and send analysis results to site storage 34. The results may illustrate user activity, history, and habit while surfing on the Internet. Main functions of site storage 34 may include collecting and storing information on almost all objects and subjects from almost all web pages. Information stored in site storage 34 may include texts, images, video, audio, documents, programs, links to web pages and website, etc.

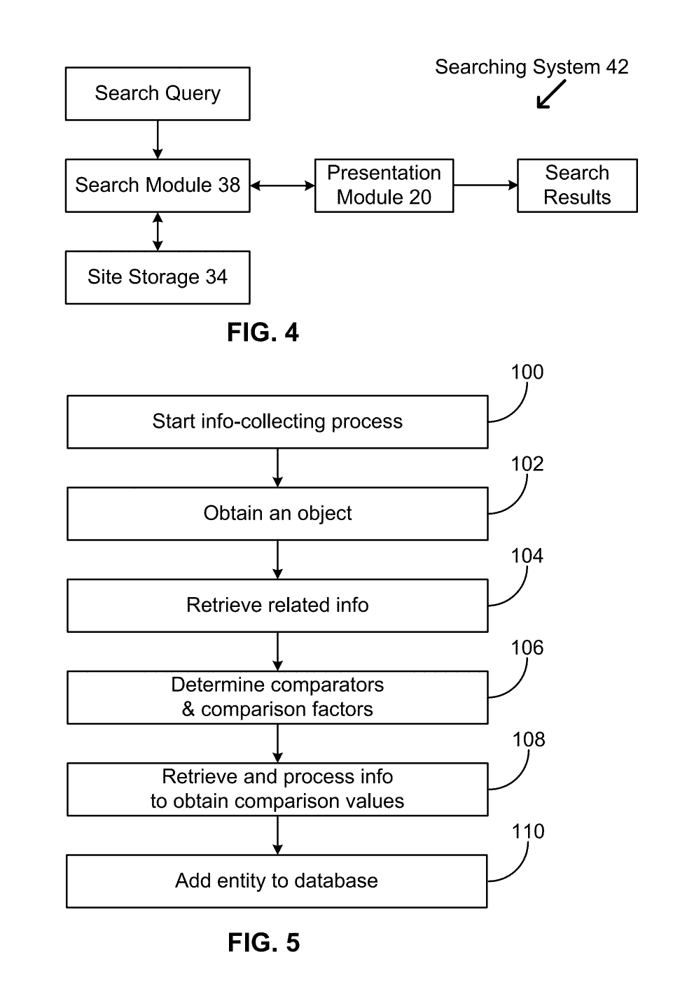

FIG. 4 is a schematic functional block diagram of a searching system 42 of a server according to the present invention. The functions illustrated in FIG. 4 may be realized by software, hardware, or a combination of hardware and software. The blocks each may represent processor, thread, and/or object. And the blocks may be integrated into less blocks or even one block without changing the functions. A search query may be any text, image, video, audio, or symbol a user submits to searching system 42. After a query is received from a user, system 42 may search the Internet accordingly, and combine the searching results with previous search results stored at site storage 34 to produce consolidated results, which may be presented to the user by text, charts, web site lists or links, etc.

Searching system 42 may comprise a search module 38 and a presentation module 20, while in practice the two modules may be integrated into one device. After search module 38 receives a search query from a user, it may analyze the query, identify a key object, access the Internet and site storage 34 to retrieve relevant documents, and then generate an initial result, which is sent to presentation module 20. Module 20 may further process the initial result, produce a search result, and then send the search result to the user. The search result may be presented in text, table, figure, or other applicable forms. The functions of presentation module 20 may include data/information categorizing, sorting, filtering, summarizing, chart and curve drawing, and other ways to present a search result. The manner a search result is displayed may be determined by user preference, analysis on user viewing history, or a predetermined arrangement. As said, search module 38 may have the capacity to access data and documents on the Internet and at site storage 34. After completing a search, search results and certain related info may be stored at site storage 34 for future use.

Theoretically, after receiving a search query from a user, a search may be performed on the Internet to collect up-to-date info. But searching the Internet takes time, as there are millions of websites. On the other hand, many users may want to get search results as soon as possible. Thus, a practical solution is to search the Internet, prepare search results for given groups of objects in advance, and build databases to store the search results at internal facilities like site storage 34 of FIG. 4. When a query comes in, instead of spending time searching the Internet, system 40 may locate a matching object at the databases and retrieve prearranged search results in a short period of time. As info posted on the Internet may be created, updated, or changed constantly, continued searches for new info and updates on the Internet become necessary. Once new data arrives, databases at site storage 34 may be updated in response.

As discussed, conventional databases consist of entities which only contain information that is directly related to an object, like web page links to introductory articles, relevant news, reviews, etc. After a query is received, an object is determined based on the query. Then a corresponding entity is identified and the entity's attributes are found. Info retrieved from the attributes is presented to a user as search results. With such database data, however, it is inconvenient and time-consuming to get comparison results, because obtaining comparison results involves comparing methods and collecting information on comparable objects. In order to get comparison info as fast as getting search results, a direct retrieval step is needed. Direct retrieval requires that a database contains relevant data which is ready for pick-up anytime. Thus, there exists a need for an improved database. The improved database may have comparison attributes. Comparison attributes may be created for an entity to store comparison data. From comparison attributes, comparison data may be retrieved instantly.

In practice, an entity, representing an object, may contain one or more comparison attributes. Comparison attribute may store data for the object and one or more comparators, where the comparators are what an object is compared to. For instance, assume that a database contains an object “Pizza Time”. Then other pizza restaurants within a certain distance may be used as comparators, i.e., a user may compare “Pizza Time” with these restaurants. After comparators are chosen, comparison factors may be selected or determined. Comparison factors represent aspects to be compared, such as price, review results, certain characteristics, certain specifications, etc. Thus, an object and its comparators may have a specific group of comparison factors, or an object and its comparators may be compared via certain aspects respectively. A value or status may be determined and assigned to an object or comparator under a comparison factor, which is called comparison value here. Hence, an object and its comparators each may have a comparison value under a comparison factor, and they may be compared by comparison values under a comparison factor. In many cases, a concise comparison report is desirable for a quick and easy review. Thus, comparison values are preferred to contain a short answer and easy-to-understand contents.

Comparison attributes contain info on objects, comparators, comparison factors, and comparison values. Once comparison attributes are arranged for an entity, a corresponding object becomes ready for direct retrieval of comparison data. Take modules or devices of FIG. 4 for instance. Assume that a database is built at site storage 34, where objects have entities with one or more comparison attributes. The comparison attributes contain info related to comparison among an object and its comparators. When a query is received from a user asking for comparison results of an object, search module 38 may launch a process to find an entity of the object and its comparison attributes. Then comparators, comparison factors, and comparison values are located at the attributes. Next, presentation module 20 may process the comparison data, generate comparison results, and send the results to the user. Examples of comparator, comparison factor, comparison value, and comparison result are presented in below.

FIG. 5 is a schematic flow diagram illustrating processes to collect data, arrange comparison info, and create a new entity in accordance with the present invention. In Step 100, a process to collect and prepare info begins. Assume that a database is already constructed and the following steps are used to add an entity to it. The database is different from a traditional database in that it contains extra attributes, comparison attributes. So, comparison data may be added to an entity according to certain rules and become part of attributes' contents. An entity stands for an object. When an entity is created for the database, data of an object is assigned to its attributes, e.g., comparison data is sent to comparison attributes. It is the comparison attributes that make the database different from traditional databases. Comparison attributes also make it convenient to retrieve comparison data for a searching system. It is noted that a comparison attribute is a complementary but not necessary part of an entity or database. An entity may or may not have valid comparison attributes. If an entity has comparison attributes, it provides ease for getting comparison results. If an entity has no comparison attribute or blank comparison attributes, the entity is still valid and useful.

In Step 102, an object is obtained. The object will be added to the database in the form of entity. Next, a search is conducted in Step 104 to retrieve info from the Internet and other sources regarding the object. Assume that it is a conventional search. Search results may be processed and distributed among matching attributes.

Since a conventional search result doesn't include needed comparison info, Steps 106 and 108 are arranged for preparing comparison attributes. It may be designed such that these two steps are arranged automatically when a new entity is created for the database. It may also be designed that when an entity of an object is created for the database, the object goes through a qualifying test first. The test may contain questions like whether the object belongs to certain kind of product or certain field of business, whether it is located in certain area if it is of business, whether a certain number of comparison requests has been received for the object, and so on. If an object passes the test, these two steps are carried out and comparison attributes are set up for its entity. If it fails the test, these two steps are skipped and its comparison attributes are left empty.

In Step 106, comparators are determined or chosen based on info of the object. For a comparison scenario, at least one comparator needs to be picked for the object. Comparators represent something comparable, i.e., they bear certain characteristics similar to the object so that they may be compared with it. For instance, for object “Pizza Time”, certain nearby pizza places may be chosen as comparators. These pizza places may resemble “Pizza Time” in terms of location and the nature of business which make them comparable to “Pizza Time”. To select comparators, certain searches and analysis are needed. Preferably, comparators may be obtained by given algorithm automatically.

Next, comparison factors are selected. A comparison factor is what to be compared with. It is meaningless to compare an object and its comparators without supporting data, which is like to compare abstract names. Objects and its comparators may be compared via factors like certain properties, specifications, characteristics, or features. For instance, price, battery life, and review rating by users may be the choices of comparison factors for a smartphone. Once comparison factors are defined, Step 108 is performed. In this step, searches are arranged to get info that is related to the object, the comparators, and the comparison factors and then the info is processed to obtain or extract comparison values for the object and each comparator. A comparison value represents a value, condition, degree, or status of an object or comparator under a comparison factor. A comparison value, as used here, has a broad meaning. It may be a numerical number, like 15, standing for fifteen hours of battery life, a textual expression, like “Excellent” for review rating, or may have another format of suitable expression. Thus, when a comparison event happens, it is the comparison values under a comparison factor that are compared for an object and its comparators.

Info of the object, its comparators, comparison factors, and comparison values may be used to created comparison attributes. After comparison attributes are prepared, they may be aggregated with other attributes of the entity. Then in Step 110, the entity may be added to the database.

Assume that an object has an entity at a database. The entity may include comparison attributes. The comparison attributes may contain info of the object, comparators, comparison factors, and comparison values. When a request for comparison results of the object is received, a search module may find the entity at the database first, and then check whether its comparison attributes are available. If the answer is yes, contents of the comparison attributes may be retrieved, and comparison values may be obtained and used for display of comparison results. Since a simple and easy report is desirable in many cases, comparison values are expected to be short and clear. Preferably, a concise summary of an object or comparator under a comparison factor may be taken as a comparison value. For instance, assume that there is a task to get a comparison value. The object is a restaurant and the comparison factor is of price. Because there are many dishes on the menu, a summarization process is needed to reflect the overall price aspect of the restaurant. One summarization method is of averaging. Prices of selected dishes are averaged to get a medium price. The medium price may be used as a concise summary of prices. It may also be used as a comparison value under the price factor for the restaurant.

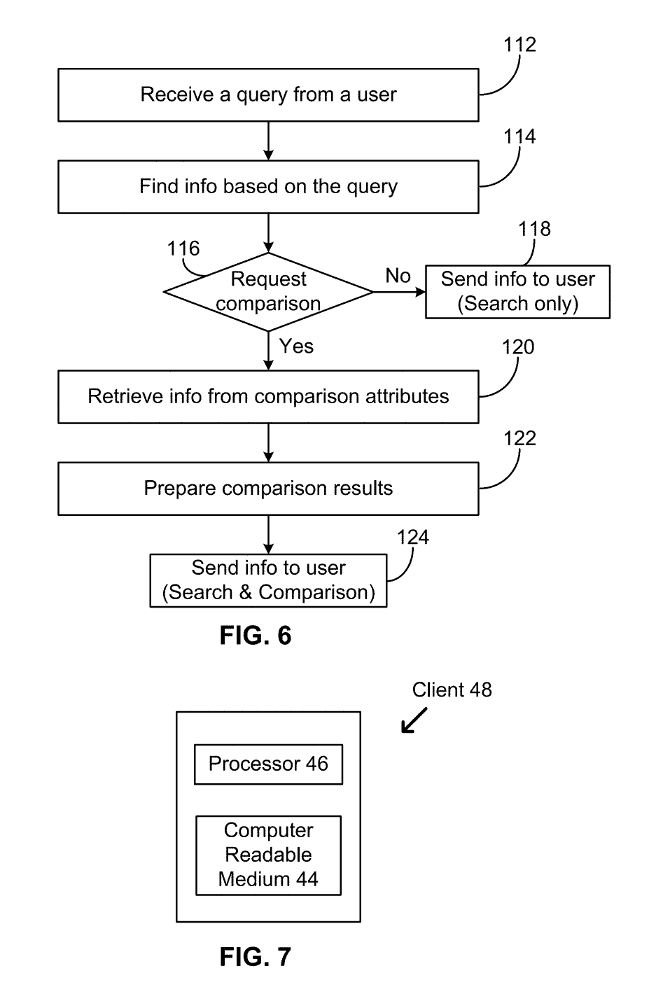

Now referring to FIG. 6. Assume that a server or searching system receives a query from a user in Step 112. The server or searching system may start a search at given databases in Step 114. Next, whether the user requests comparison results is determined in Step 116. If the user asks for a conventional search, Step 118 is taken and conventional search results are retrieved and sent to the user. Conventional search results contain results based on a query or around an object only. The results don't provide comparison info directly. If the user wants comparison results, Step 120 is performed. Contents of comparison attributes are retrieved by algorithm automatically. But not all contents of comparison attributes are presented to a user at a time. Instead, data at comparison attributes is processed by the server or searching system in Step 122, during which some attribute contents may be selected based on the query and certain arrangements. In Step 124, selected attribute contents as comparison results are sent to the user.

When a user requests comparison info, conventional search results may or may not be sent to the user. As comparison results and conventional search results are complementary and both may be in need even when a user requests the former, it may be arranged that both may be given to the user as a default setting. In practice, options may be presented to a user. A user may choose comparison results only to skip conventional search results, or choose to have comparison and search results presented together.

FIG. 7 is an exemplary block diagram of a client system 48 according to the present invention. As discussed, client 48 may represent an electronic device, including but not limited to a desktop computer, a laptop computer, a tablet computer, a smartphone, a smart watch, a VR or AR device, etc. Client 48 may include a processor 46 and computer readable medium 44. Processor 46 may mean one or more processor chips or systems. Medium 44 may include a memory hierarchy built by one or more memory chips or storage modules like RAM, ROM, FLASH, magnetic, optical and/or thermal storage devices. Processor 46 may run programs or sets of executable instructions stored in medium 44 for performing various functions and tasks, e.g., surfing or searching on the Internet, playing video or music, electronic payment, social networking, sending and receiving emails, short messages, files, and data, executing other applications, etc. Client 48 may also include input, output, and communication components, which may be individual modules or integrated with processor 46. Communication components may connect the device to a server or another device via communication network. Usually, client 48 may have a display (not shown in FIG. 7 for brevity reason) and a graphical user interface (GUI). A display may have liquid crystal display (LCD) screen, organic light emitting diode (OLED) screen (including active matrix OLED (AMOLED) screen), or LED screen. A screen surface may be sensitive to touches, i.e., sensitive to haptic and/or tactile contact with a user, especially in the case of smart phone, tablet computer, smart watch, and certain wearable devices. A touch screen may be used as a convenient tool for a user to enter input and interact with a system.

Furthermore, client 48 may have a voice recognition component to receive user's verbal command or audio input. In addition, client 48 may have a gesture detection mechanism to receive user's gesture instructions. For VR and AR devices and some wearable devices, a virtual screen or screen having a very small size may be arranged. A virtual screen may be part of a displaying system which may not have a physical screen structure. While it is impractical or inconvenient to touch a virtual screen or very small screen, verbal command and gesture instructions may become useful for users. In discussions below, word “screen” or “display” may include devices that are virtual or very small. For the latter case, a screen may be smaller than a one-inch-by-one-inch square or even smaller than a fingertip. A search interface or search window may be presented via all kinds of screens or displays.

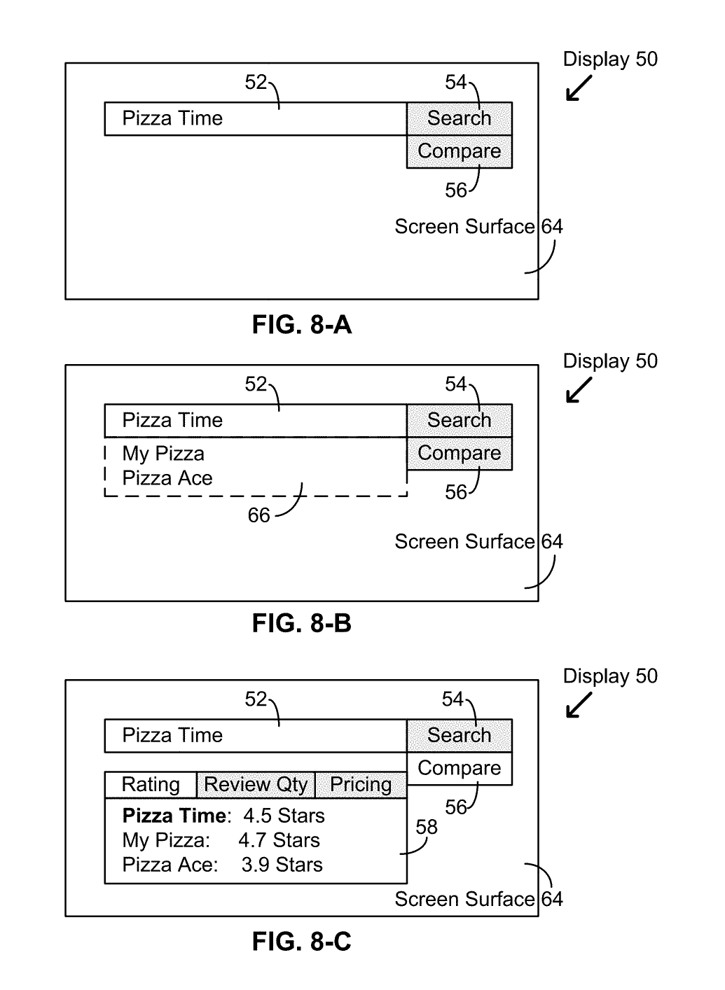

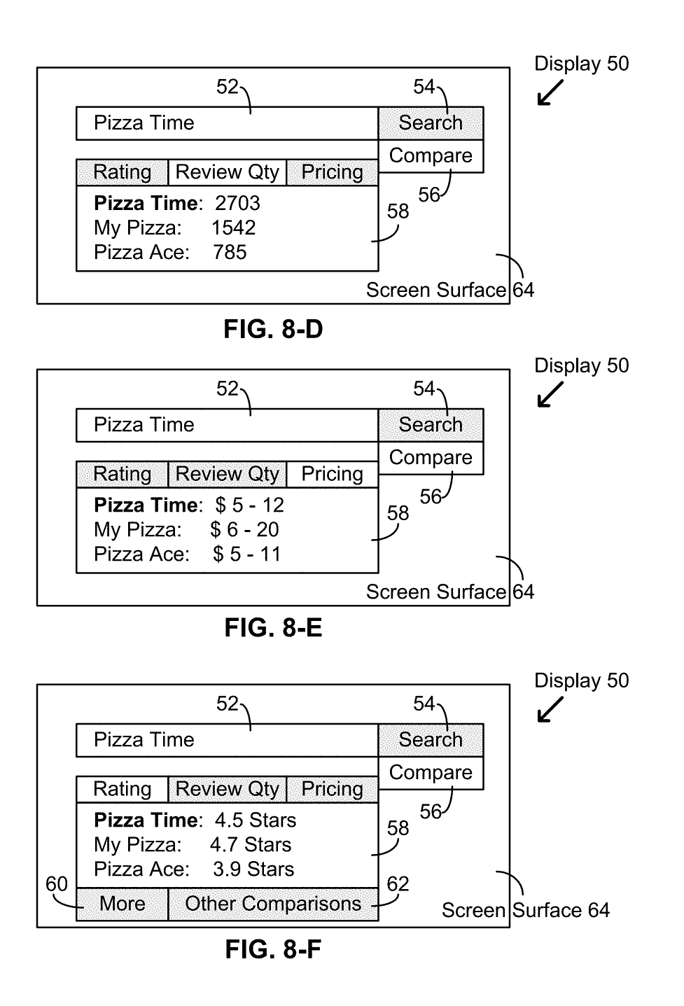

A server or searching system may provide for a user comparison results via a client system or electronic device. Embodiments are presented in exemplary diagrams of FIGS. 8-A to 8-F. These figures depict configurations to show comparison results schematically. Assume that a search interface or search window is presented on a screen surface 64 of a display 50. Display 50 may belong to an arbitrary client system or electronic device. The search interface may be a portal page of a search website. The scene on surface 64 may also be part of a screen view which mainly serves other programs, where searching functions are provided as a necessary and important service. For instance, many websites, like online stores and business reviews sites, have a searching area or search window on their web pages. In order to accommodate a searching task, a query input window 52 is arranged on surface 64. Window 52 may be used by a user to enter a query in a searching effort. Also arranged are interactive graphic icons or buttons 54 and 56. Button 54 serves as a search button, which may be labeled “Search” or other searching symbols. A user may click on it or tap it, assuming surface 64 is touch sensitive, to start a search process or a conventional search process. For a conventional search interface or search window on screen, a search button is the only option provided. A user may only go through this button to conduct a search, whether a searching target is about an object or relations among objects.

On surface 64 however, a comparison button is arranged, which may be labeled “Compare” or another symbol expressing the compare meaning. For the convenience of use, comparison button 56 is preferred to be placed in a close distance to search button 54, like next to it. When the two buttons are side by side, it is easy for a user to see them simultaneously and select one quickly and easily. Comparison button 56 may be arranged beneath button 54 as shown in the figure, on the top of button 54, or on the right hand side of it. In the latter arrangement, input window 52, buttons 54 and 56 form one line, which may be preferred in some applications. Moreover, button 56 may be arranged in an invisible state in a search interface or search window, and only become visible beside button 54 after query input window 52 receives some input. Thus, comparison button 56 may be arranged in an invisible state at the beginning of a search process. Once a user starts keying in a word in window 52 or window 52 receives any input, button 56 may come to the interface from the invisible state. An invisible comparison button means one less icon and may be helpful for arranging a neat screen view.

As shown in FIG. 8-A, a query “Pizza Time” is entered in window 52. After button 54 is tapped, a conventional search around “Pizza Time” is launched. On the other hand, when button 56 is tapped, a search for comparison results is initiated. To get comparison results, a searching system may first determine that the object is “Pizza Time” and then find out whether there is an entity at a database which represents object “Pizza Time”. In this case, it is relatively simple to figure out a matching object from the query, as it is the query itself. If a query matches more than one object, a searching system may select one based on prearranged rules and begin a search process via the selected object. Alternatively, when a query matches multiple objects, a searching system may proceed along another route which is described in below.

Return to FIG. 8-A. It is noted that the screen view remains the same after a query is keyed in, and the screen view may change once button 54 or 56 is tapped. As another configuration, when comparison results are available for an object, it may be arranged that certain comparators may show up automatically right after a query is entered, which is described graphically in FIG. 8-B. For instance in the figure, after a user types “Pizza Time” in window 52, a temporary comparison window 66 may show up below window 52. Two comparators “My Pizza” and “Pizza Ace” may be presented in the temporary window. The two comparators may be selected from a group of comparators at comparison attributes. Window 66 may help a user in a search process, as it provides certain comparison info in advance. But appearance of a temporary comparison window doesn't mean comparison results will be displayed. A user may still need to tap button 56 for that. In the meantime, a user may also tap button 54 for a conventional search.

In addition, it may be designed that after a user keys in a word or part of a word, temporary window 66 may show up and display a list of suggested queries. The suggested queries may be made based on a user's search history and possible queries containing the incomplete input. If a suggested query matches an object on record, selected comparators may appear along with suggested queries in the window. When comparators and suggested queries are shown in the window together, a symbol like “Compare” may be arranged beside the comparators to distinguish them from the queries. After viewing contents in a temporary window, a user may either tap a suggested query and a search button for a conventional search, or tap a suggested query and then a comparison button for comparison results. So, temporary window 66 may be arranged to assist both kinds of searches.

When button 56 is tapped, its color and brightness may change to show user selection and comparison results may be retrieved and presented as in FIG. 8-C. Once a searching system receives a query and comparison request, the system finds an object which matches the key item of the query. For query “Pizza Time”, assume that there exists an object with the same name. Then, the object's entity and attributes are located at a database. From the comparison attributes, comparators, comparison factors, and comparison values are retrieved. Due to individual conditions of each case and screen size limit, not all comparators may be presented at a time. In the figure, two comparators “My Pizza” and “Pizza Ace” are selected and presented in a comparison window 58. The two pizza places may be chosen based on their business nature and close distance to “Pizza Time”. For the object and two comparators, a comparing act may be performed through comparison factors. Again, there may be many comparison factors. A searching system may select a few of them for a user according to prearrangements. Assume that comparison factors “Rating”, “Review Qty”, and “Pricing” are chosen and presented in window 58 as a default setting. In window 58, there are three interactive icons which represent the comparison factors and bear their names respectively. When an icon is tapped, color of the icon may become brighter and corresponding comparison values may appear.

After window 58 is open, values of “Rating” are shown as the first comparison results on display. The term “Rating” may be used to reflect how users feel about a business or product. For instance, on some reviews sites or in feedback emails, a user may be asked to rate a service or product, like using the number of stars. Summarization of the ratings, which may be done by averaging method, may generate an average value. The average value may be used as a comparison value as well as a concise summary. In the figure, the three businesses have 4.5, 4.7, and 3.9 stars respectively. Thus, it becomes easy and quick to compare the pizza places in terms of rating.

Next, the user may be interested in the “Review Qty” factor and the user may tap its icon to get comparison results which reveal the quantity of reviews each business receives in a given period of time. The results are shown graphically in window 58 of FIG. 8-D. Quantity of reviews, which were written and posted by users, may shed light on the popularity of a place. More reviews may mean more customers and more popular. Thus comparison factor of review number may be a useful indicator when a user is making a decision on where to have a meal. The last comparison factor chosen by the searching system is of “Pricing”. A user may tap on its icon and get a screen view as in FIG. 8-E. Unlike the other two comparison factors, a value of “Pricing” factor may be a range, instead of a single number, although the average price may be used as the comparison value too. A price range may show the lowest price and the highest price. Although a list of average prices is easy for comparison, a price range may still be favored by some users and especially by restaurant owners, as it provides more information.

Therefore, it is seen that comparison results are easy to get via a comparison button and furthermore, an object may be compared with comparators quickly and conveniently by comparison values. As said, a concise summary for an object or comparator may be used as a comparison value. Consequently, a comparing act may be actually performed by comparing concise summaries. Thus, for convenience purpose, concise summaries may be specifically arranged so that they are easy and quick to view and comprehend. For instance, concise summaries may be arranged to have the same presentation format, similar or even the same wording, and/or have only a few elements only. Summary elements may include numerical number, word, letter, character, sign, or symbol. Comparison values as seen in FIGS. 8-C to 8-D are examples of concise summaries, which are arranged to have the same format, same wording, and a few elements only.

As a default configuration and practical need, only a few comparators are selected for presentation by a searching system, like the two pizza places in the above. Since some users may want to compare an object with more comparators or some comparators chosen under different rules, more choices may be arranged in a comparison window. For instance in FIG. 8-F, two interactive buttons, button 60 “More” and button 62 “Other Comparisons” are created. When button 60 is tapped, more comparators may be presented so that comparisons may be held among more pizza businesses or in a wider range. For instance, certain pizza places located farther away may be included. It is assumed that the corresponding comparison attributes have more than two comparators so that more results may be available upon request. Button 62 represents another option which may be used to choose comparators through a different method. For instance, after button 62 is tapped, another icon may show up with a label “Restaurants with similar price” and then different comparators may show up, which may be, for instance, a burger joint and a pancake restaurant that may have a similar price range. When comparators are changed, comparison factors may still remain the same. Again, for this option to be effective, comparison attributes may be arranged to have needed info prepared in advance. It is seen that button 60 and 62 provide additional options for comparison. The additional options may not be necessary, but may satisfy needs of some users.

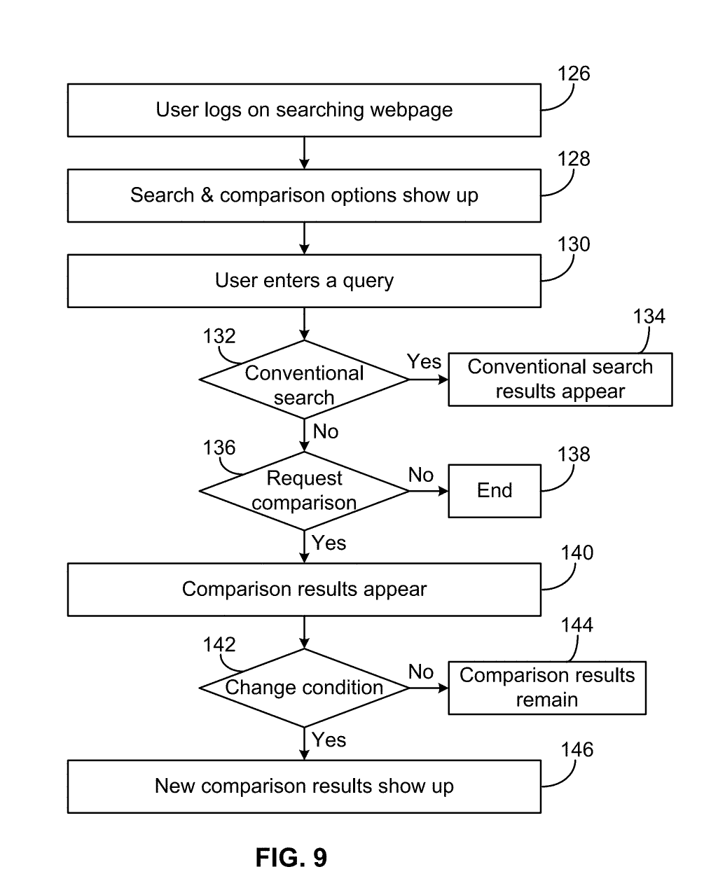

In FIG. 9, an exemplary flow diagram is presented which illustrates getting comparison results from a user point of view. Assume that a user logs on a searching web page in Step 126. On the web page as described in Step 128, two options are configured to show up, which may be designed as two interactive buttons. One option provides a conventional search, while the other option leads to comparison results. Next the user enters a query in a query input window in Step 130. Then, the user faces two choices in Step 132. The issue is whether the user wants to do a conventional search. If the answer is yes, the user activates a search button. Then, conventional search results are displayed in Step 134. If the user doesn't want to do a conventional search, two more choices are depicted in Step 136 which is about comparison act. If the user chooses to activate a comparison button, comparison results are obtained and presented in Step 140. If the comparison button is not selected in a given period of time, the search process may end in Step 138. Next in Step 142, the user needs to make another decision, i.e., whether to change the comparison condition. If the user doesn't change it, comparison results presented on screen remain the same for certain time in Step 144. If the user activates a button to change comparison condition, like increasing the number of comparators, showing more comparison factors, or changing comparison method, new comparison results may be retrieved and presented in Step 146.

### CONCLUSION, RAMIFICATIONS, AND SCOPE

Thus it can be seen that apparatus and methods are introduced to improve searching methods and enhance databases.

The described embodiments have the following features and advantages:
(1). Two options, search and comparison options, are provided in a search window;
(2). Comparison option provides comparison results, while search option provides conventional search results;
(3). Comparison results are presented using concise summaries;
(4). Database is improved by addition of comparison attributes;
(5). Comparison attributes contain comparison data; and
(6). Comparison attributes enable retrieval of comparison data directly.

Although the description above contains many specificities, these should not be construed as limiting the scope of the invention but as merely providing illustrations of some of the presently preferred embodiments. Numerous modifications will be obvious to those skilled in the art.

### Ramifications:

The interface on screen surface 64 of FIGS. 8-C to 8-F may show more contents than what is depicted. As discussed, even though comparison results among an object and its comparators are requested by a user, conventional search results may still be in need. Hence, conventional search results may be retrieved and presented in an area below window 58. When a user looks at comparison results about an object and becomes interested in the object, the user may tap a link to learn more about it conveniently.

A comparison button like “Compare” button may be placed close to a search button no matter what interface a search button is arranged in. In other words, comparison functionality may be arranged to take effect in any interface where searching functionality exists. The interface may be a web page of a searching website, an online store website, a business reviews website, a government website, etc.

Rules may be made for selecting comparators for an object. To qualify as a comparator, it must have the same or similar features or characteristics, when compared to the object. Some features or characteristics make them comparable, and some other features or characteristics are what a comparison is based on, wherein the latter is called comparison factors here. For instance, if an object is a product, other products which have similar specifications but different brands may be taken as comparators. And they may be compared by price, common parameters, or other comparison factors. Besides, other products of the same brand and similar functions may be used as comparators too. If an object is a book, other books which have the same or similar topic may be enlisted as comparators. And they may be compared by review rating, price, number sold, etc. In addition, other books written by the same author but with different topics may also serve as comparators. If an object is a restaurant, nearby restaurants of the same cuisine may be chosen as comparators. Moreover, nearby restaurants which have different cuisine but similar price may serve as comparators too. If an object is a country, neighboring counties or countries which the media often cite when reporting it may be selected as comparators.

Rules may also be made for selecting comparison factors. An object and its comparators are compared by comparison values under a group of comparison factors. As comparisons may be made via many aspects, there may be many potential comparison factors. Thus, it may be necessary to have certain rules which define which comparison factor should be presented to a user. The rules may be related to users' needs and general trend. In addition, similar objects may have the same requirements for comparison factors. For a product, possible comparison factors may include price, review rating, life time, key specifications, etc. For a book, possible comparison factors may include price, review rating, quantity sold, etc. For a country, likable comparison factors may be population, area, gross domestic product (GDP), and so on.

Besides clicking and tapping using a computer mouse or fingertip, vocal instructions may also be used to do a search and get search or comparison results, when a client system is equipped with a voice recognition component. Vocal input may be especially favored when VR and AR devices are involved, since input via tapping on a screen surface becomes unavailable. For instance, after a search interface like that of FIG. 8-A shows up on a virtual screen, a user may speak to a VR device, “Key in “Pizza Time” please” and then “Compare” to start a comparing process and get comparison results under factor “Rating”. Next the user may say “Pricing” to change comparison factor from “Rating” to “Pricing”. In addition, when a gesture sensor is available at a VR device, a user may use virtual clicking or virtual tapping acts to enter input. Then the user may get comparison results via gesture instructions.

Sometimes when the purpose of search is to get certain images or videos, it may be arranged such that search results are presented using images or links to web pages containing videos. For such a searching process, a comparison button may still be arranged next to a search button to provide a comparison option. It may be arranged such that besides text, an image or video alone may represent a comparison value or concise summary as well. In other words, a comparison value or concise summary may contain an image or a video only. For instance in a comparison window like that of FIG. 8-C, images or links to video websites for an object and its comparators may be displayed under a comparison factor. A video clip may also be embedded in an icon in a search window. The icon may stand for a comparison value. A user may tap the icon to view the video directly. Thus aside from comparing things by textual contents, a comparison may be made by comparing images or videos too.

In many cases, comparison results may be presented using a few numbers or a few short texts in a search window. But a user may want to see comparison results in images or videos in some occasions, even though a search is not conducted among images or videos. For instance, when a user is looking at comparison results made up of numbers and words, the user may want to compare the parties by images or videos. Thus, additional comparison factors may be created at comparison attributes and named, for example, “Image” and “Video”. Accordingly, additional comparison factor icons, such as “Image” and “Video”, may be arranged along with other comparison factor icons in a comparison window. Accordingly, some comparison value may be arranged to be a selected image or video clip that represents an object. For a restaurant, a representative image may be a picture of its popular dish or an award-winning interior design. For a movie, a representative video may be its trailer. When “Image” or “Video” factor is selected, images or videos chosen for an object and its comparators may be displayed together, which make it convenient to compare them. Comparison of images or videos may be useful when a user tries to choose a movie, a TV show, a concert, a restaurant, a park, and so on.

When a query or object has multiple meanings, multiple temporary comparison windows like window 66 of FIG. 8-B may appear in a search interface. The multiple windows may represent the meanings respectively. A user may tap one window to select one meaning and then tap a comparison button to start a search act. Next comparison results based on the selected meaning may be retrieved and displayed.

In FIG. 8-F, an “Edit” button may be configured in the interface (not shown in the figure). The button may provide options to adjust rules for selecting comparators and comparison factors. For instance, a user may tap “Edit” button to open an edit window and then enter an editing mode. In the mode, the user may change parameters and conditions which define a comparator selecting process. For instance, a user may change the maximum distance allowed between an object and a comparator. The user may also add for an object requirement for delivery service or requirement for online ordering service. The user may also specify which comparison factors may show up first.

As in some cases a user may want to see detailed info after viewing concise summaries, an interactive button, which may have label “Detail”, may be configured on surface 64 of FIG. 8-F (not shown in the figure). The button may be designed to provide a list of links of review reports or articles. So a user may start a search for comparison info on an object, take a look at concise summaries provided as comparison results, and then tap “Detail” button to retrieve links to review papers which may be related to the concise summaries. To accommodate such a function, more info may be collected and added to comparison attributes of entities or objects. So, comparison attributes may have not only comparison values which are in a concise form, but also links to sources from which comparison values are derived and links to web pages containing related info. From the links, a user may access articles, news, posts, or reports on an object. Materials from these links differ from conventional search results, because their contents may be related to comparison topic directly or indirectly. For instance, a comparison-related article may contain lengthy or brief comments or analysis on relations between an object and another object, or contain data on both objects.

Lastly, an interactive arrow button may be configured on the right hand side of “Pricing” button of FIGS. 8-C to 8-F (not shown in the figures). The arrow button may be placed next to “Pricing” button and have an arrow symbol on it that points to the right-hand direction. If the arrow button is tapped, an icon of a new comparison factor may appear. A user may tap the new icon to see values under the new comparison factor for the three pizza places. Thus the arrow button brings options for more comparison factors and consequently more comparison results. Again, it is assumed that comparison attributes contain more comparison factors than those shown in a comparison window. The arrow icon enables a user to select every comparison factor available at comparison attributes, which provides flexibility for comparison window design and convenience for users.

Therefore the scope of the invention should be determined by the appended claims and their legal equivalents, rather than by the examples given.

1. A system arranged for working with a device having a displaying apparatus and stored executable instructions, comprising:
1) a communication component for arranging communication between the system and the device via a communication network; and
2) a receiving component for receiving a query for a search process from a user;
3) a comparing component for obtaining an object based on the query and obtaining one or more comparators which are comparable to the object;
4) a presentation component for arranging simultaneously an interactive search element and interactive comparison element in an interface produced by the displaying apparatus, wherein the search element provides an option to present in the interface search results based on the query, and the comparison element provides another option to present in the interface comparison results based on the object and the one or more comparators; and
5) the communication component arranged to send the user the search results and/or comparison results after receiving the query.

2. The system according to claim 1 wherein the search element and comparison element are configured next to each other in the interface.

3. The system according to claim 1 wherein the comparison element is configured to appear in the interface from an invisible state after part of the query is received at the device.

4. The system according to claim 1 wherein the presentation component is arranged to present in the interface a plurality of concise summaries of the object and the one or more comparators.

5. The system according to claim 4 wherein the plurality of concise summaries is arranged to have the same presentation format.

6. The system according to claim 4 wherein the plurality of concise summaries is arranged to contain no more than a few items besides expression of summary identity, the items including number, word, letter, character, sign, symbol, image, and video.

7. The system according to claim 1 wherein the presentation component is arranged to present in the interface a plurality of choices for comparing the object and the one or more comparators via different comparison factors.

8. A computer implemented method performed for presenting search and comparison results comprising:
1) arranging communication between a system and a device via a communication network, said device having a displaying apparatus and stored executable instructions;
2) configuring an interface using the displaying apparatus and a query input window in the interface for receiving a query for a search process;
3) presenting simultaneously in the interface an interactive search element and interactive comparison element, wherein the search element provides an option to present in the interface search results based on the query, and the comparison element provides another option to present in the interface comparison results based on an object and one or more comparators; and
4) the object arranged based on the query and the one or more comparators being comparable to the object.

9. The method according to claim 8, further including arranging the search element and comparison element next to each other in the interface.

10. The method according to claim 8 wherein the comparison element is configured to appear in the interface when part of the query is received in the query input window.

11. The method according to claim 8, further including presenting a plurality of concise summaries as the comparison results for the object and the one or more comparators.

12. The method according to claim 11 wherein the plurality of concise summaries is arranged to have the same presentation format.

13. The method according to claim 11 wherein the plurality of concise summaries is arranged to contain no more than a few items besides expression of summary identity, the items including number, word, letter, character, sign, symbol, image, and video.

14. The method according to claim 8, further including presenting in the interface a plurality of choices for comparing the object and the one or more comparators via different comparison factors.

15. A computer implemented method performed for presenting search and comparison results comprising:
1) generating an interface at a device;
2) configuring a query input window in the interface for a search process;
3) receiving a query from a user;
4) determining an object based on the query;
5) obtaining one or more comparators which are comparable to the object;
6) presenting in the interface a plurality of concise summaries as comparison results for the object and the one or more comparators; and
7) presenting in the interface a plurality of options for presenting different concise summaries for the object and the one or more comparators via different comparison factors.

16. The method according to claim 15, further including presenting simultaneously in the interface an interactive search element and interactive comparison element, wherein the search element provides an path to present in the interface search results based on the query, and the comparison element provides another path to present in the interface the comparison results based on the object and the one or more comparators.

17. The method according to claim 15 wherein the plurality of concise summaries is arranged to have the same presentation format.

18. The method according to claim 15 wherein the plurality of concise summaries is arranged to contain no more than a few items besides expression of summary identity, the items including number, word, letter, character, sign, symbol, image, and video.

19. The method according to claim 15 wherein the query is received through a voice recognition component.

20. The method according to claim 15 wherein at least one of the concise summaries contains an image or video only.
